(19) United States
(12) Patent Application Publication
(10) Pub. No.: US 2003/0039177 A1
(43) Pub. Date: Feb. 27, 2003

(54) Disc storage and selective retrieval system and method

(75) Inventors: Assaf Malul, Jerusalem (IL); Amit Dar, Modi'in (IL)

Correspondence Address: Dr Mark Friedman Ltd, c/o Bill Polkinghorn Discovery Dispatch, 9003 Florin Way, Upper Marlboro, MD, 20772, US

(73) Assignee: ERNST & YOUNG TRUST CORP (BVI) LTD

(21) Appl. No.: 09/934,672

(22) Filed: Aug. 23, 2001

(51) Int. Cl. G11B 17/04; G11B 17/08

(52) U.S. Cl. 369/30.6; 369/30.61

(57) ABSTRACT

A system and method for the storage and selective retrieval of discs is described. For selective retrieval of a disc, a feed unit is positioned such that a slot is located opposite a designated disc, a gate is opened and the designated disc rolls by the force of gravity into the slot and the rolling of remaining discs are stopped by a belt and, after the selected disc is retrieved, the gate closes, returning the remaining discs into the storage position.

### FIELD AND BACKGROUND OF THE INVENTION

The present invention relates to a system and method for storage and selective retrieval of audio, visual or information storage media and, more particularly, to a computerized system that conveniently stores a large number of discs, such as video and /or audio discs, compact discs, CD-ROMS, DVDs and the like in a relatively small box which is either a stand-alone or connected to a computer.

Juke-boxes that play selected discs in public places have been around since 1889. In one form of a juke-box, the discs are stored in juxtaposition in compartments. Each compartment is associated with a particular key in a bank of such keys. When a key is depressed, a carriage is moved up to the selected compartment, withdraws the disc therefrom and places it on a turntable. To maintain this special association between a key and a particular disc, it is essential that the disc be stored only in its predetermined allocated compartment. This requirement for placing a disc in a special compartment can become very cumbersome. When inserting discs of the latest hit tunes and when replacing discs of less popular pop music with discs that are requested more frequently, one must follow a very special system. If this system is not observed, a disc other than the selected disc will be played on the turntable.

U.S. Pat. No. 4,314,366 to Galia teaches a method that permits the haphazard insertion and replacement of discs without following a particular system or sequence and nevertheless obtain a proper relationship or association between each selecting key and a particular disc. Galia's invention provides for each disc to be coded, the coding of all the discs is scanned successively and, when the selected disc has been detected, a dispensing mechanism is actuated, the disc is dispensed and then placed on the turntable. Galia's invention thus departs from the teaching of the prior art in which the compartments are associated with the selecting keys. Instead, each disc is individually coded. The association is therefore no longer by way of the compartment but directly between a key and a disc. The disadvantage is that Galia's invention necessitates having a light conductor for each compartment which is space demanding and expensive.

U.S. Pat. No. 6,134,212 to Pines et al teaches an optical disc changer assembly and a magazine for transporting discs. The discs are seated in a vertical position and are held there by gravity and friction. An intricate system is described by Pines et al wherein a CD is placed in a predetermined position and retrieved for subsequent playing in a jukebox. The disadvantage of Pine's patent is in order to extract a disc from the tightly packed rack of discs, an intricate mechanism is required to lift the disc up from the rack and also when the CD is being played in the jukebox it renders the assembly inoperable to accept any more for storage or similarly it doesn't allow for the removal of CDs for the duration of the music being played. Additionally the position that the disc is to be placed in is predetermined and not set by the assembly.

U.S. Pat. No. 5,724,321 to Vishlitzky teaches a storage and retrieval system for tapes, cassette and discs. Vishlitzky's invention is based on having at least one empty media storage location within each row or column within a three dimensional cabinet. There are numerous rows described with each media storage location being able to be shuffled or moved within the row. The disadvantage of Vishlitzky's invention is that the cabinet is too voluminous and the system for retrieval is too complex.

U.S. Pat. No. 4,907,889 to Simone teaches a retrieval and sequencing system for a videocassette library. Simone describes at least one cassette carousel and a multi-axis cassette transfer robot for gripping and transporting the selected cassettes. The disadvantage of Simone's system is that the cabinet is too voluminous and the system for retrieval is too complex.

U.S. Pat. No. 5,946,278 to Tower describes a computer storage and selection system that conveniently stores, selects and identifies the storage location for retrieval by the user of a large number of discs, cassettes and tapes and the like. Tower's system selects the storage location based upon user input, including partial or fragmentary input. A system computer optically senses and stores the content and selected storage location of each media device. Tower's system responds to user requests for specific media by recalling the storage location of the disc and identifying the location for quick retrieval by the user. The CD is read or scanned utilizing optical reader prior to entry into a storage location. Once scanned, the CD is placed into a storage location causing an actuator to depress a switch. A controller receives the switch signal from a switch and identifies the particular storage location with the particular CD information scanned. The information is retained within the user database. Additional information can be added to the database beyond that previously scanned. The disadvantage of Tower's system is that each CD must be stored within its own CD Jewel Box, which is voluminous and that each storage space has an actuator and a switch and a light for showing the user the location of the selected CD, which then has to be manually extricated.

There is thus a widely recognized need for, and it would be highly advantageous to have, a system for selection, storage and retrieval of discs devoid of the above limitations.

### SUMMARY OF THE INVENTION

According to one aspect of the present invention there is provided a system for storage and retrieval of discs. The system includes a disc housing having a front portion with an opening for storage and removal of the discs and a back portion. The disc housing further includes individual grooves configured for supporting the discs in a substantially vertical position and further configured to tend to cause the discs to roll by the force of gravity towards the front of the disc housing, an electronic control unit, a gate configured to support the discs in a storage position so as to prevent the discs from rolling out of the disc housing due to the force of gravity, the gate being responsive to gate opening and closing signals from the electronic control unit to open so as to allow the discs to roll out from the disc housing and a disc insertion and retrieval mechanism, the mechanism configured for moving along an axis adjacent to the front portion of the disc housing in response to a disc selection signal from the electronic control unit. The disc insertion and retrieval mechanism includes a feed unit including a feed slot through which a disc is loaded, an interior end facing the disc housing and an exterior end facing away from the disc housing and a feed mechanism for feeding a disc from the interior end to exterior end and from the exterior end to the interior end a belt driven by a motor responsive to a disc selection signal from the electronic control unit, the belt configured for moving the feed unit along the axis, the belt further configured for supporting the discs so as to prevent the discs from rolling out due to the force of gravity when the gate is open, such that for selective retrieval of a disc, the feed unit is positioned such that the slot is located opposite a designated disc, the gate is opened and the designated disc rolls by the force of gravity into the slot and the rolling of remaining discs are stopped by the belt and, after the selected disc is retrieved, the gate closes, returning the remaining discs into the storage position.

According to another aspect of the present invention there is provided a method for storing discs. The method comprising the steps of providing a disc storage device including a disc housing, a disc insertion and retrieval mechanism and a reader for reading a marking associated with the disc, inserting a disc into the disc insertion and retrieval mechanism, if the marking is successfully read, storing the disc in a given position in the disc housing; and if the marking is not successfully read, rejecting the disc.

According to further features in preferred embodiments of the invention described below, the system further comprises an identifying mechanism for identifying a marking on a disc, the marking selected from the group consisting of an optically readable marking, a magnetic marking and an electronic marking. The identifying mechanism being associated with the disc insertion and retrieval mechanism.

According to still further features in the described preferred embodiments, the marking is deployed as an annular marking on the disc.

According to still further features in the described preferred embodiments, the system further includes a mechanism for applying the marking to the disc.

According to still further features in the described preferred embodiments, the system further includes a voice recognition system, the voice recognition system configured for providing an input into the electronic control unit.

According to still further features in the described preferred embodiments, the system of further includes an input device and an output device configured for entering properties of the disc and for retrieval of the disc.

According to still further features in the described preferred embodiments, the disc housing further includes a cover.

According to still further features in the described preferred embodiments, the method, further comprises the steps of retaining the discs in the disc storage device in individual grooves configured for supporting the discs in a substantially vertical position and further configured to tend to cause the discs to roll by the force of gravity towards the front of the disc housing, providing a gate configured for supporting the discs and prevent the discs from rolling out of the disc housing due to the force of gravity, opening the gate allowing the discs to roll out from the disc housing; and providing a belt associated with the disc insertion and retrieval mechanism configured for moving the disc insertion. and retrieval mechanism along an axis adjacent to the front of the disc housing, the belt further configured for supporting the discs and preventing the discs from rolling out due to the force of gravity when the gate is open.

According to still further features in the described preferred embodiments, the reader of the marking associated with the disc is a barcode reader or an optic reader or a magnetic reader, or an electronic reader.

The present invention successfully addresses the shortcomings of the presently known configurations by providing a system for selection, storage and retrieval of discs.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is an illustration of a system for storage and retrieval of discs;

FIG. 2 is an illustration of a disc insertion and retrieval mechanism;

FIG. 3 is an illustration of an annular marking on a disc

FIG. 4 is an illustration of a marking application mechanism; and

FIG. 5 is a block diagram of a method for storing discs.

### DESCRIPTION OF THE PREFERRED EMBODIMENTS

The present invention is of a system and method for the storage and selective retrieval of stored media. Specifically, the present invention is used to store many discs in a relatively small housing and have a simple gravity aided method for the storage and selective retrieval of marked discs.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

For purposes of this specification and the accompanying claims, the term “disc” generally refers to discs and disks, such as video and /or audio discs, compact discs, CD-ROMS, DVDs, rewritable disks which is sometimes spelt disk with a “k” including CD-Rs and DVD-Rs written on one side or two-sides.

A non-limiting example of a disc storage and selective retrieval system and method is described herein below.

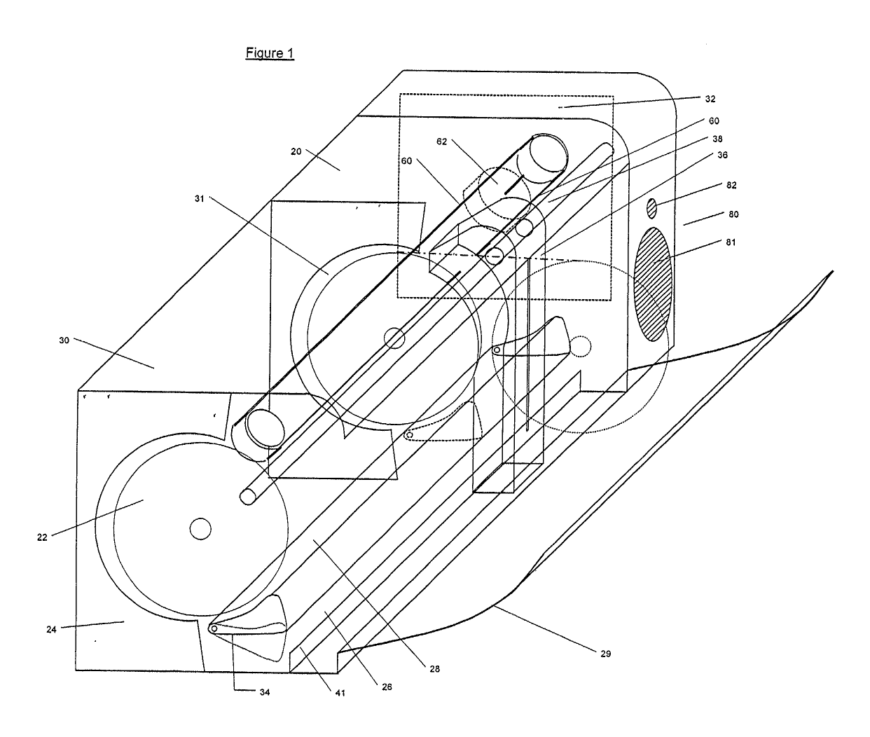

Referring now to the drawings, FIG. 1 is of a system 20 for storage and retrieval of discs 22. System 20 includes a disc housing 24 having a front portion 26 with an opening 28 for storage and removal of discs 22 and a back portion 30. Disc housing 24 further includes individual grooves 31 configured for supporting discs 22 in a substantially vertical position and further configured to tend to cause discs 22 to roll by the force of gravity towards the front 26 of disc housing 24. In a preferred embodiment of this invention groove 31 is “C” shaped and is configured for supporting approximately less than half of the disc's circumference 22. A typical distance between the discs may be less than 0.5 mm giving a total width of 18 cm necessary for storing each 100 discs. A cover 29 configured to cover the front 26 of disc housing 24 serves to protect system 20's mechanism and discs 22 from the exterior environment such as from dust.

System 20 further includes an electric control unit 32. Electric control unit 32 is configured to control the movement of the internal parts in the storage and selective retrieval of discs 22. AC or DC current supply or a combination of both powers system 20.

System 20 further includes a gate 34 configured to support the discs 22 in a storage position so as to prevent discs 22 from rolling out of disc housing 24 due to the force of gravity. Gate 34 is responsive to gate opening and closing signals from electronic control unit 32 to open so as to allow discs 22 to roll out from disc housing 24.

System 20 further includes a disc insertion and retrieval mechanism 36. Disc insertion and retrieval mechanism 36 is configured for moving along an axis 38 adjacent to front portion 26 of disc housing in response to a disc selection signal from electronic control unit 32.

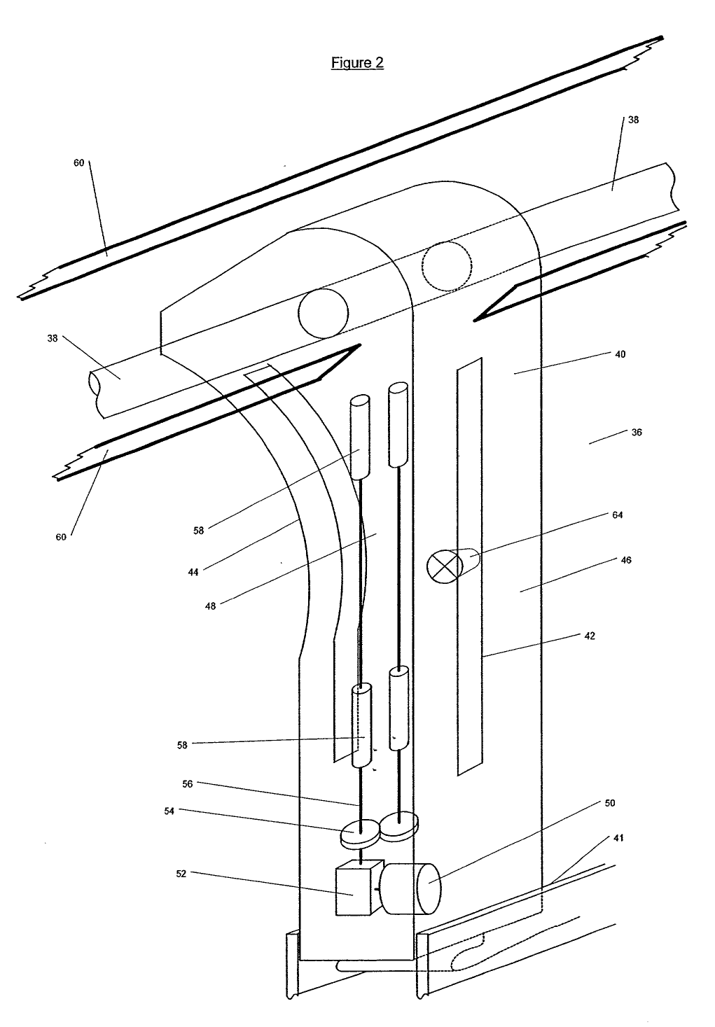

FIG. 2 is an illustration of disc insertion and retrieval mechanism 36. Disc insertion and retrieval mechanism 36 includes a feed unit 40. Feed unit 40 includes a feed slot 42 through which a disc 22 is loaded, an interior end 44 facing disc housing 24 and an exterior end 46 facing away from disc housing 24 and a feed mechanism 48 for feeding a disc 22 from interior end 44 to exterior end 46 and from exterior end 46 to interior end 44. Feed unit 40 running in a feed unit track 41 that further stabilizes the movement of feed unit 40.

Feed mechanism 48 according to a preferred embodiment includes a roll motor 50, a transmission box 52, a roll transmission 54, a roll shaft 56 and roll cylinders 58. Roll cylinders 58 are made of rubber-like material and function as the holding and feeding element for disc 22 passing through feed unit 40.

Disc insertion and retrieval mechanism 36 further includes a belt 60 driven by a motor 62 responsive to a disc selection signal from electronic control unit 32. Belt 60 is configured for moving feed unit 40 along axis 38. Belt 60 is further configured for supporting discs 22 so as to prevent discs 22 from rolling out due to the force of gravity when gate 34 is open. After gate 34 opens, all of discs 22 in disc housing 24 fall forward and are caught by belt 60, except for the disc 22 that falls forward into slot, then being fed through the feed slot 42 by the feed mechanism as there is no belt obstructing feed slot 42.

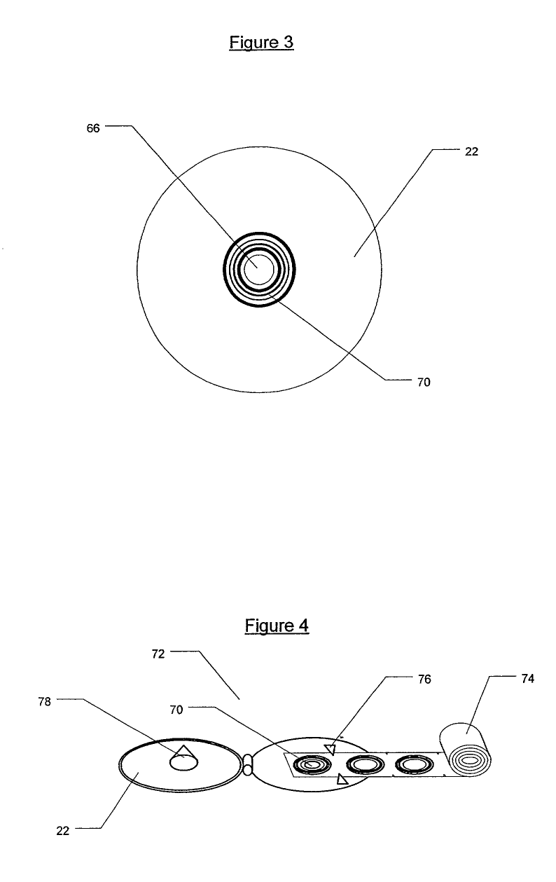

System 20 further includes an identifying mechanism 64. Identifying mechanism 64 is configured for identifying a marking 70 (FIG. 3) on a disc. Marking 70 is for example an optically readable marking such as a barcode, or a magnetic marking or an electronic marking. Identifying mechanism 64 is associated with disc insertion and retrieval mechanism 36.

Marking 70 is preferable employed as an annular marking. An advantage of having an annular marking is that marking 70 on disc 22 is read without the necessity of placing disc at any particular angle or rotating the disc into feed unit 40. FIG. 2 illustrates feed unit 40 with a single identifying mechanism 64 which would necessitate either feeding disc 22 into feed unit 40 with marking 70 being on the same side as identifying mechanism 64. Marking both sides of disc 22 and/or having a second identifying mechanism 64 positioned on the other side of feed slot 42 enables feeding a marked disc into feed unit 40 from any side of disc 22. A preferred position on disc 22 for annular marking 70 is towards the center 66 of disc, although marking in alternate positions on disc 22 such as close to the outer perimeter is possible.

Identifying mechanisms are readily available on the market. If marking 70 is an optic marking such as a barcode then an optic reader will be incorporated into identifying mechanism 64. Additionally or alternately, a magnetic marking will require the use of a magnetic reader and an electronic marking will require the use of an electronic reader. More than one type of reader can be incorporated into feed unit 40 simultaneously.

FIG. 4 illustrates a marking application mechanism 72, which in a preferred embodiment is incorporated into system 20, either as a separate entity adjoining the system, or as an integral part of the system. For example the side of the system housing may contain a dedicated section for applying the marking.

Marking application mechanism 72 typically includes a roll 74 of marking stickers 70, securing tabs for holding roll 74 in place and a disc centering cone 78 for positioning disc 22 in a position for adhering marking to disc 70. Marking application mechanisms are commercially available, for example NEATO disc labeler kit manufactured by: Fellowes Mfg., 1789 Norwood Ave. Itasca Ill. 60143. P/N: 99940.

According to a preferred embodiment of the present invention, system 20 includes a voice recognition system 80 configured for providing an input into electronic control unit 32. Voice recognition system 80 includes a microphone 81, an optional speaker 82 combined with commercially available hardware and software which will enable at least partial operation of system 20 by voice commands. Voice detection hardware and software is commercially available from Dragon Naturally Speaking, 6782 Belvedere Rd.. West Palm Beach Fla. 33413. Additionally or alternately, voice recognition system 80 could include readily available hardware and software for voice synthesis for a verbal exchange with the operator of system 20 in case of uncertain command recognition.

System 20 further includes an input device (not shown) and an output device (not shown) configured for entering properties of disc 22 and for retrieval of disc 22. Typically an input device is a keyboard onto which information concerning a disc to be stored and/or a disc to be retrieved is entered. A typical output device is a display monitor that displays certain properties of disc 22 to be stored or retrieved and of system 20.

System 20 can be a stand-alone system or alternately be connected to a computer either directly or remotely controlled. A program supplied with system 20 enables the operator of system 20 to search for a particular disc.

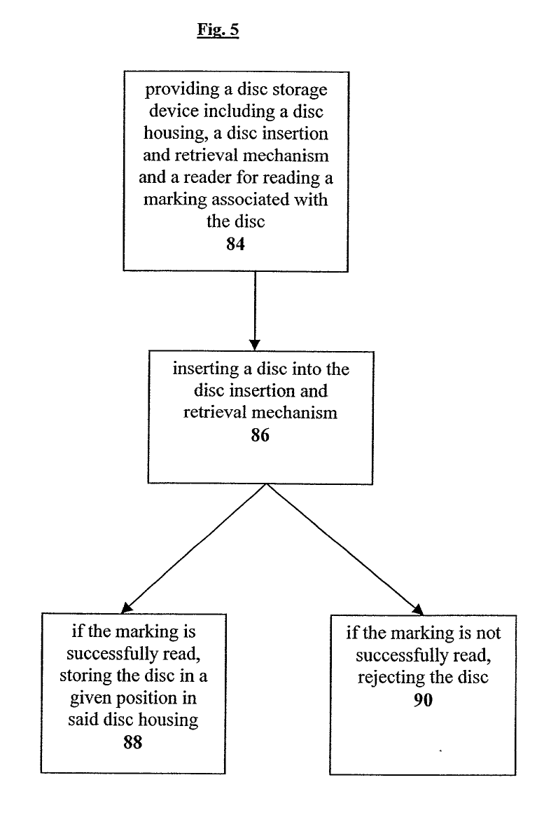

The present invention is further embodied by a method (FIG. 5) for storing discs. The method includes providing 84 a disc storage device including a disc housing, a disc insertion and retrieval mechanism and a reader for reading a marking associated with the disc. The method further includes the step of inserting 86 a disc into said disc insertion and retrieval mechanism. The method further includes the step of storing the disc if the marking is successfully read 88, then in an empty position in the disc housing. Alternately, if the marking is not successfully read 90, the disc is rejected.

In an alternative embodiment of the present invention the method includes the step of retaining the discs in the disc storage device in individual grooves configured for supporting the discs in a substantially vertical position and further configured to tend to cause the discs to roll by the force of gravity towards the front of the disc housing. The method further includes the steps of providing a gate configured for supporting the discs and prevent the discs from rolling out of the disc housing due to the force of gravity, opening the gate allowing the discs to roll out from the disc housing; and providing a belt associated with the disc insertion and retrieval mechanism configured for moving the disc insertion and retrieval mechanism along an axis adjacent to the front of the disc housing, the belt further configured for supporting the discs and preventing the discs from rolling out due to the force of gravity when the gate is open.

In operation, for selective retrieval of a disc, a request for a particular disc is fed into system 22 by either voice recognition system 80, a keyboard a command from an optional dedicated front panel keyboard, a command from a computer, a command generated by an arbitrary controller (such as a PDA, a Tablet, or even a cellular phone) and sent to the control unit 32 via a communication line (Serial communication like a PC Corn ports, USB, LAN, wireless LAN or even Infra-Red connection). Prior to or following the request for a particular disc 22, cover 29 is opened. A disc selection signal from electronic control unit 32 moves feed unit 40 to be positioned such that feed slot 42 is located opposite a designated disc 22. Gate 34 is opened and designated disc 22 rolls by the force of gravity into slot 42 and the rolling of remaining discs 22 are stopped by belt 60. Selected disc 22 is then grabbed by feed mechanism 48 that transfers disc 22 through the exterior end 46 of feed unit 40, where it is taken by the user (or any additional mechanism). After selected disc 22 is retrieved, gate 34 closes; returning remaining discs 22 into the storage position, and then the user closes cover 29.

For the storage of a particular disc 22, it is necessary to differentiate between a new disc and the return of a disc that has previously been stored. A new disc that has no marking and therefore cannot be recognized by identifying mechanism 64 is first placed into marking application mechanism 72 wherein marking 70 is adhered to disc 22. Information concerning disc 22 is entered by using the input device so that marking 70 will correspond to the information fed into system 20 by the user for future retrieval. If there already exists a marking on the disc that is recognized by marking application mechanism 72, the user can choose to alter the information concerning the particular disc. Cover 29 is opened. A disc selection signal from electronic control unit 32 moves feed unit 40 to a position opposite an empty groove. When feed unit 40 is in position, gate 34 is opened and the user places disc 22 into feed slot 42. Disc 22 is then grabbed by feed mechanism 48 which transfers disc 22 from exterior end 46 though interior end 44 of feed unit 40. At this point if identifying mechanism 64 does not recognize a marking 70, the disk 20 is rejected by feed mechanism 48 back to the exterior end 46. Otherwise, disc 22 falls into onto designated groove 31. Now (whether disc 22 has been rejected or accepted) cover 29 is closed and gate 34 returns to closed position. The gate plus belt gravity-fed retrieval mechanism allows very compact storage by avoiding the need for insertion of a gripping tool between the stored discs.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A system for storage and retrieval of discs, the system comprising:
(a) a disc housing having a front portion with an opening for storage and removal of the discs and a back portion, said disc housing further including individual grooves configured for supporting the discs in a substantially vertical position and further configured to tend to cause the discs to roll by the force of gravity towards said front of said disc housing;
(b) an electronic control unit;
(c) a gate configured to support the discs in a storage position so as to prevent the discs from rolling out of said disc housing due to the force of gravity, said gate being responsive to gate opening and closing signals from said electronic control unit to open so as to allow the discs to roll out from said disc housing; and
(d) a disc insertion and retrieval mechanism, said mechanism configured for moving along an axis adjacent to said front portion of said disc housing in response to a disc selection signal from said electronic control unit, said disc insertion and retrieval mechanism including:
(i) a feed unit including a feed slot through which a disc is loaded, an interior end facing said disc housing and an exterior end facing away from said disc housing and a feed mechanism for feeding a disc from said interior end to exterior end and from said exterior end to said interior end;
(ii) a belt driven by a motor responsive to a disc selection signal from said electronic control unit, said belt configured for moving said feed unit along said axis, said belt further configured for supporting the discs so as to prevent the discs from rolling out due to the force of gravity when said gate is open,
such that for selective retrieval of a disc, said feed unit is positioned such that said slot is located opposite a designated disc, said gate is opened and said designated disc rolls by the force of gravity into said slot and the rolling of remaining discs are stopped by said belt and, after said selected disc is retrieved, said gate closes, returning said remaining discs into said storage position.

2. The system of claim 1, further comprising an identifying mechanism for identifying a marking on a disc, said marking selected from the group consisting of an optically readable marking, a magnetic marking and an electronic marking, said identifying mechanism being associated with said identifying mechanism.

3. The system of claim 2, wherein said marking is deployed as an annular marking on said disc.

4. The system of claim 3, further including a mechanism for applying said marking to said disc.

5. The system of claim 1, further including a voice recognition system, said voice recognition system configured for providing an input into said electronic control unit.

6. The system of claim 1, further including an input device and an output device configured for entering properties of said disc and for retrieval of said disc.

7. The system of claim 1, wherein said disc housing further includes a cover.

8. A method for storing discs, the method comprising the steps of:
(a) providing a disc storage device including a disc housing, a disc insertion and retrieval mechanism and a reader for reading a marking associated with the disc;
(b) inserting a disc into said disc insertion and retrieval mechanism;
(c) if said marking is successfully read, storing the disc in a given position in said disc housing; and
(d) if said marking is not successfully read, rejecting the disc.

9. The method of claim 8, further comprising the steps of:
(e) retaining the discs in said disc storage device in individual grooves configured for supporting the discs in a substantially vertical position and further configured to tend to cause the discs to roll by the force of gravity towards the front of said disc housing;
(f) providing a gate configured for supporting the discs and prevent the discs from rolling out of said disc housing due to the force of gravity;
(g) opening said gate allowing the discs to roll out from said disc housing; and
(h) providing a belt associated with said disc insertion and retrieval mechanism configured for moving said disc insertion. and retrieval mechanism along an axis adjacent to said front of said disc housing, said belt further configured for supporting the discs and preventing the discs from rolling out due to the force of gravity when said gate is open.

10. The method of claim 8, wherein said marking is deployed as an annular marking on the disc.

11. The method of claim 8, wherein said reader of said marking associated with the disc is a barcode reader.

12. The method of claim 8, wherein said reader of said marking associated with the disc is an optic reader.

13. The method of claim 8, wherein said reader of said marking associated with the disc is a magnetic reader.

14. The method of claim 8, wherein said reader of said marking associated with the disc is an electronic reader.
